(19) United States
(12) Patent Application Publication
(10) Pub. No.: US 2011/0036697 A1
(43) Pub. Date: Feb. 17, 2011

(54) Linking mechanism for key switch assembly

(75) Inventor: Chih-Cherng Lin, George Hill (AI)

Correspondence Address: BACON & THOMAS, PLLC, 625 SLATERS LANE, FOURTH FLOOR, ALEXANDRIA, VA, 22314-1176, US

(73) Assignee: ALL VISION GROUP LIMITED, George Hill (AI)

(21) Appl. No.: 12/461,398

(22) Filed: Aug. 11, 2009

(51) Int. Cl. H01H 13/705

(52) U.S. Cl. 200/344

(57) ABSTRACT

A linking mechanism used in a key switch assembly is disclosed to include a first link, which is shaped like an open frame, and a second link, which is receivable within the first link. The first link and the second link are respectively symmetrically configured and obliquely coupled between a key cap and a positioning plate above a circuit module in a crossed manner for performing a scissor action to guide vertical movement of the key cap relative to the circuit module for enabling the key cap to be pressed by a user to trigger the circuit module in producing a control signal.

### BACKGROUND OF THE INVENTION

1. Field of the Invention

The present invention relates to an input device and more particularly, to a linking mechanism for use in a key switch assembly of an input device which has the first link and second link thereof symmetrically configured, facilitating installation.

2. Description of the Related Art

A conventional key switch structure for keyboard has a linking mechanism provided between a key cap and a bottom board to support vertical movement of the key cap. The linking mechanism may be made in the form of a cross-linkage (scissors-structure), rotary structure or sliding structure. FIG. 7 illustrates a scissor action design of key switch structure for input device according to the prior art. According to this design, the key switch structure comprises a bottom board C, a circuit board D supported on the bottom board C and carrying a rubber cone D1, a key cap B, and a linking mechanism A coupled between axle holders C1 of the bottom board C and axle holders B1 of the key cap B around the rubber cone D1. The linking mechanism A includes an inner link A1 and an outer link A2. The inner link A1 has a base A11, two axles A111 respectively located on the left and right sides of the base A11 on the middle, two support arms A112 protruded from the rear side of the base A11, two pivot pins A12 respectively located on the two support arms A112, two extension arms A113 protruded from the front side of the base A11, and a shaft A13 connected between the two extension arms A113. The outer link A2 has two arms A21, two axle holes A211 respectively located on the two arms A21 and respectively pivotally coupled to axles A111 of the inner link A1, a reinforcing portion A212 and a connection portion A22 connecting the two arms A21, and axles A23 and pins A24 respective extended from the connection portions A22 at two sides. The pivot pins A12, shaft A13 of the inner link A1 and the axles A23 and pins A24 of the outer link A2 are respectively coupled to the axle holders C1 of the bottom board C and the axle holders B1 of the key cap B.

According to the aforesaid linking mechanism A, the support arms A112 and the extension arms A113 have different widths, the pivot pins A12 and the shaft A13 are differently configured, the inner link A1 is not symmetrically configured; the reinforcing portion A212 and the connection portion A22 are connected to the two arms A21 and the axles A23 and the pins A24 are respectively protruded from the top side of the reinforcing portion A212 and the bottom side of the connection portion A22, therefore the outer link A2 is not symmetrically configured. Further, the inner link A1 and the outer link A2 are partially overlapped in vertical direction and have escape means to facilitate relative motion. The asymmetrical configuration design limits installation of the linking mechanism to a particular direction.

Due to directional installation limitation, the inner link A1 and the outer link A2 must be kept in the correct direction so that the linking mechanism A can be accurately installed. Further, even the directional position of the inner link A1 and the outer link A2 has been checked, the installation sequence of the inner link A1 and the outer link A2 cannot be changed. This installation procedure is complicated, wasting much time and labor and lowering the product yield rate.

### SUMMARY OF THE INVENTION

The present invention has been accomplished under the circumstances in view. It is the main object of the present invention to provide a linking mechanism for key switch assembly, which is symmetrically configured to facilitate installation. It is another object of the present invention to provide a linking mechanism for key switch assembly, which prolongs the work life of the key switch assembly.

To achieve these and other objects of the present invention, a linking mechanism comprises a first link and a second link. The first link and the second link are obliquely coupled between a key cap and a positioning plate above a circuit module in a crossed manner for performing a scissor action to guide vertical movement of the key cap relative to the circuit module for enabling the key cap to be pressed by a user to trigger the circuit module in producing a control signal. Further, the first link and the second link are symmetrically configured in all directions. Therefore, it is not necessary to consider the installation direction of the first link and the second link when fastening the linking mechanism to the positioning plate and the key cap, facilitating fabrication and installation of the key switch assembly.

Further, the first link has two symmetrical narrow elongated base portions arranged in parallel and two symmetrical connection arms connected between the two narrow elongated base portions in a parallel manner. Each connection arm has a middle part and a coupling hole located on the middle part at an inner side. The second link has two pivot pins respectively pivotally coupled to the coupling holes of the first link. Further, each coupling hole of the first link has a top open side and a bottom open side. The design of the top and bottom open sides of the coupling holes of the first link enables the pivot pins of the second link to be coupled to the coupling holes of the first link from either the top side or the bottom side so that the user can selectively install the first link or the second link at first when coupling the linking mechanism to the positioning plate. This installation convenience greatly improves the yield rate of the product.

Further, the middle part of each connection arm of the first link is made outwardly protruded and vertically thickened and the pivot pins of the second link are respectively extended from respective protruding reinforcing portions at the left and right sides of the flat base of the second link. Therefore, the first link and the second link will not be forced to deform or to break when they are moved relative each other to perform a scissor action, prolonging the work life of the linking mechanism.

### BRIEF DESCRIPTION OF THE DRAWINGS

FIG. 1 is an exploded view of a key switch assembly constructed according to the present invention.

FIG. 2 is an exploded, sectional side view in an enlarged scale of the key switch assembly shown in FIG. 1.

FIG. 3 is an exploded view of the linking mechanism according to the present invention.

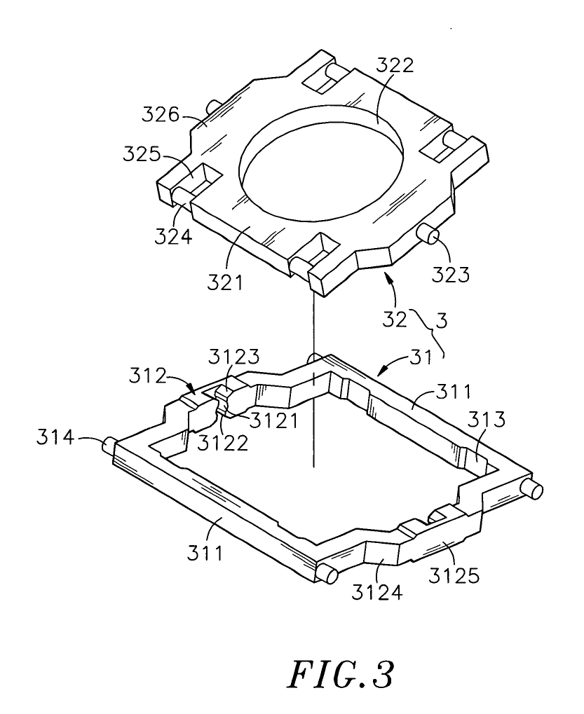

FIG. 4 is a schematic drawing of the present invention, showing the linking mechanism installed in the positioning plate above the circuit module before installation of the key cap.

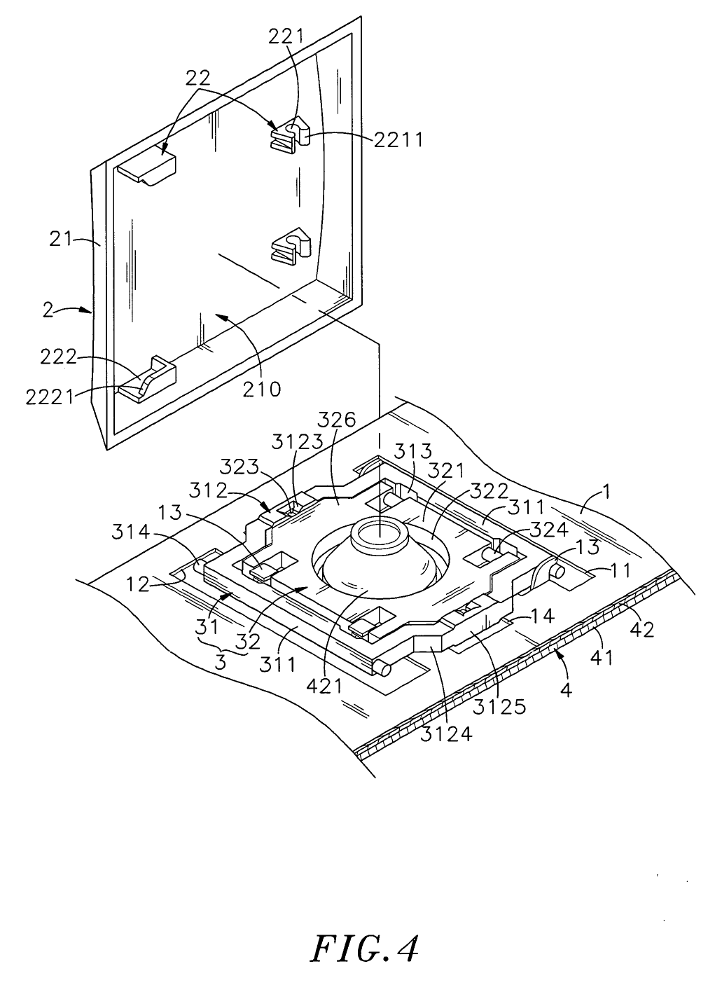

FIG. 5 is a sectional assembly view of the key switch assembly in accordance with the present invention.

FIG. 6 is a sectional view of the preset invention, showing another mounting example of the key switch assembly.

FIG. 7 is an exploded view of a key switch assembly according to the prior art.

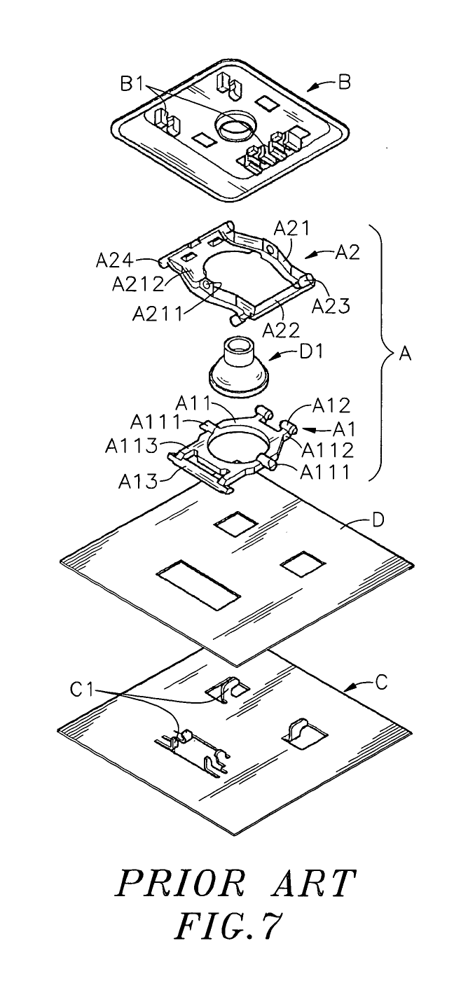

### DETAILED DESCRIPTION OF THE PREFERRED EMBODIMENT

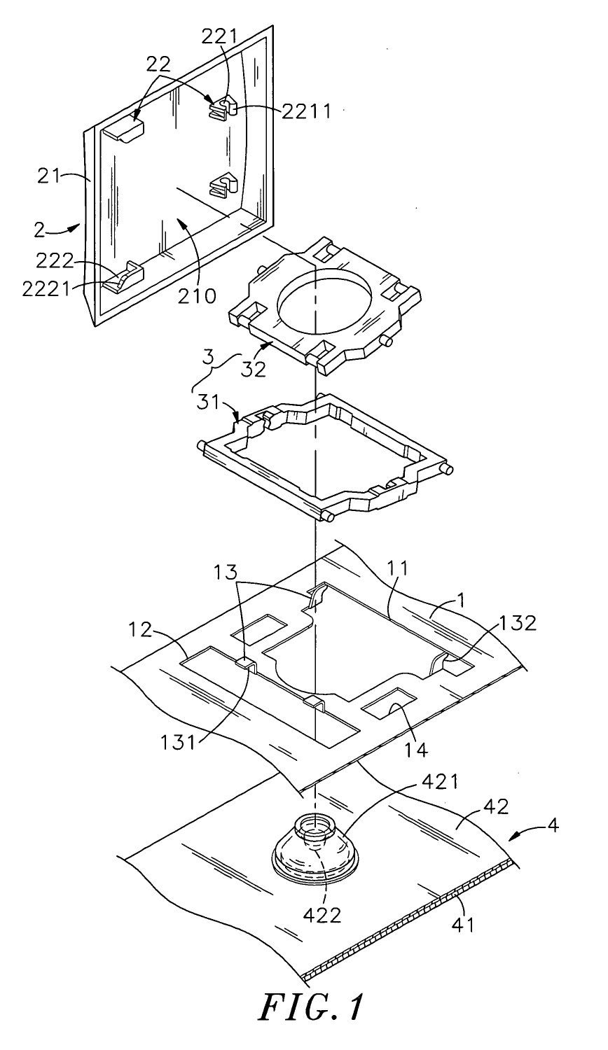

Referring to FIGS. 1˜4, a key switch assembly of an input device is shown comprising a positioning plate 1, a key cap 2, a linking mechanism 3 and a circuit module 4.

The positioning plate 1 has an opening 11 and a slot 12 cut through the top and bottom walls thereof and disposed adjacent to each other, and two pairs of coupling lugs 13 protruded from the top wall and respectively disposed at the border area of the opening 11 and the border area of the slot 12. The coupling lugs 13 are made having an angled or smoothly arched configuration. According to the present preferred embodiment, the two coupling lugs 13 that are disposed at one side of the slot 12 are angled lugs each defining a track 131; the two coupling lugs 13 that are disposed at the border area of the opening 11 at two opposite sides are smoothly arched lugs each defining a smoothly arched bottom retaining surface 132.

The key cap 2 is supported on the circuit module 4, having a hollow trapezoidal key cap body 21, a bottom accommodation space 210 defined in the bottom side of the hollow trapezoidal key cap body 21 and two pairs of coupling members 22 protruded from the bottom side of the hollow trapezoidal key cap body 21 within the bottom accommodation space 210. Each coupling member of one pair of coupling members 22 is formed of a plurality of coupling elements 2211, defining a water drop-like coupling hole 221. Each coupling member of the other pair of coupling members 22 defines a sliding groove 222 and an entrance 2221 on one end of the sliding groove 222.

The linking mechanism 3 comprises a first link 31 and a second link 32 that are received in the bottom accommodation space 210 of the key cap 2 and coupled between the hollow trapezoidal key cap body 21 and the positioning plate 1 for enabling the key cap 2 to be moved vertically upwards or downwards relative to the circuit module 1. The first link 31 has two narrow elongated base portions 311 arranged in parallel and two connection arms 312 connected between the two narrow elongated base portions 311 in a parallel manner and constituting with the two narrow elongated base portion 311 a configuration shaped like a rectangular open frame, and a pivot pin 314 respectively axially extended from each of the two distal ends of each of the two narrow elongated base portion 311. Each connection arm 312 has a middle part 3125 protruding outwards and vertically thickened, a coupling hole 3121 located on the outwardly protruded and vertically thickened middle part 3125 at an inner side, each coupling hole 3131 having top and bottom open sides 3122, two beveled guide surface portions 3123 bilaterally disposed in each of the top and bottom open sides 3122, and two sloping surface portions 3124 bilaterally formed on the outwardly protruded and vertically thickened middle part 3125 at an outer side. Further, each narrow elongated base portion 311 of the first link 31 has two vertical grooves 313 disposed at an inner side. The second link 32 comprises a flat base 321 receivable in the space surrounded by the two narrow elongated base portions 311 and two connection arms 312 of the first link 31, an opening 322 cut through the top and bottom sides of the flat base 321, two protruding reinforcing portions 326 respectively located on the left and right sides of the flat base 321, two pivot pins 323 respectively perpendicularly extended from the protrusions 326 and respectively coupled to the coupling holes 3121 of the two narrow elongated base portions 311 of the first link 31, two symmetrical pairs of holes 325 respectively located on front and rear sides of the flat base 321 and a coupling rod 324 respectively suspending in each of the holes 325.

The circuit module 4 comprises a circuit board 41, and a rubber membrane 42 positioned on the circuit board 41. The circuit board 41 has arranged therein a circuit layout with multiple switching contacts. The rubber membrane 42 carries a compressible and elastically deformable hollow actuation member 421. The compressible and elastically deformable hollow actuation member 421 is insertable through the opening 11 of the positioning plate 1, the space surrounded by the two narrow elongated base portions 311 and two connection arms 312 of the first link 31 and the opening 322 of the second link 32 for compression by the key cap 2, having a contact portion 422 downwardly extended from the top thereof and spaced above one switching contact of the circuit board 41.

The circuit board 41 of the aforesaid circuit module 4 can be a flexible circuit board made of a flexible substrate. Further, the circuit board 41 can be made by arranging a respective circuit layout on each of two substrates and then bonding the two substrates together with a conducting adhesive. Further, the rubber membrane 42 can be formed integral with the circuit board 41, or separately made and then positioned on the circuit board 41. Further, the elastically deformable hollow actuation member 421 can be molded from silicon rubber, rubber, or any other elastically deformable material. Further, light emitting means can be mounted on the inside or outside of the circuit board 41. Further, the key cap 2 can be a metal or plastic cap coated with a coating layer and carrying a design that can be a pattern, letter, character or symbol indicative of the position arrangement of the key cap 2. The design can be formed on the key cap 2 by means of a laser technique.

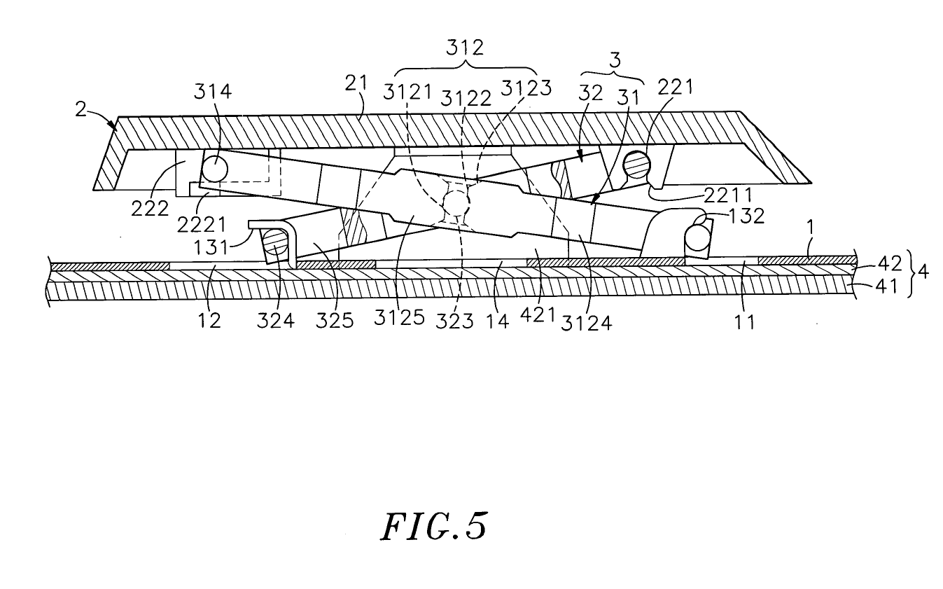

Referring to FIG. 5 and FIG. 14 again, during installation of the present invention, couple two pivot pins 314 of the first link 31 to two coupling lugs 13 of the positioning plate 1 respectively, and then couple two coupling rods 324 of the second link 32 to the other two coupling lugs 13 of the positioning plate 1, and then attach the pivot pins 323 of the second link 32 to the beveled guide surface portions 3123 in the top open sides 3122 of the coupling holes 3121 of the first link 31 and impart a downward pressure to force the pivot pins 323 of the second link 32 through the associating beveled guide surface portions 3123 into the coupling holes 3121 of the first link 31. Thus, the first link 31 and the second link 32 are pivotally coupled together for performing a scissors action.

Further, when fastening the linking mechanism 3 to the positioning plate 1 and the key cap 2, the key cap 2 is held in a tilted condition and then attach one pair of coupling members 22 to two pivot pins 314 of the first link 31 to have the pivot pins 314 be respectively forced through the respective entrances 2221 into the respective sliding grooves 222, and then the key cap 2 is turned about the pivot pins 314 to horizontal to have the other pair of coupling members 22 be respectively aimed at the two coupling rods 324 at one side of the flat base 321, and then an automatic installation tool means of is used and operated to press the cap body 21 of the key cap 2 toward the positioning plate 1, moving the respective coupling rods 324 relative to the coupling elements 2211 of the respective coupling members 22 into the respective water drop-like coupling holes 221. The design of this linking mechanism 3 facilitates quick installation by an automatic installation tool means to reduce the installation cost. Therefore, the invention is practical for mass production, increasing the yield rate.

Thereafter, the elastically deformable hollow actuation member 421 of the rubber membrane 42 of the circuit module 4 is inserted through the opening 11 of the positioning plate 1, the first link 31 and the second link 32 and stopped against the bottom wall of the cap body 21 of the key cap 2. Thus, the linking mechanism 3 is coupled between the key cap 2 and the positioning plate 1 to guide vertical movement of the key cap 2 relative to the circuit module 4 smoothly.

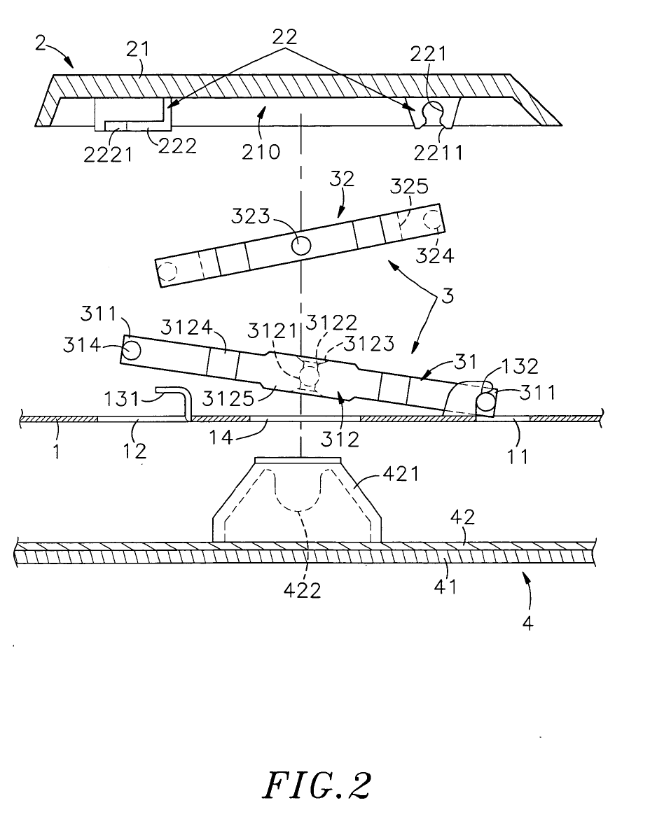

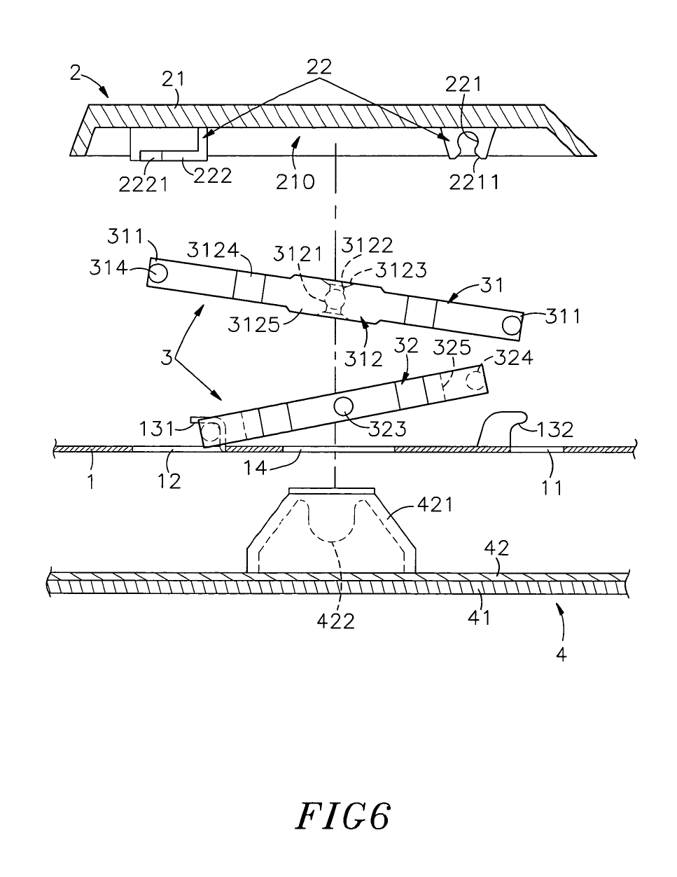

Referring to FIG. 6 and FIGS. 2, 3 and 5 again, the first link 31 and the second link 32 are symmetrically configured so that the first link 31 or the second link 32 can be rotated horizontally or vertically through 180-degrees in either of two reversed directions without changing its installation configuration. Therefore, it is not necessary to adjust the first link 31 or the second link 32 to one specific direction for installation. Further, because each coupling hole 3121 of the first link 31 has top open sides 3122, the two pivot pins 323 of the second link 32 can be accurately aimed at and forced into the coupling holes 3121 of the first link 31 either the first link 31 or the second link 32 has been installed at first. Thus, the design of the first link 31 and the second link 32 facilitates quick installation of the key switch assembly.

When a user presses the cap body 21 of the key cap 2, the coupling members 22 force the first link 31 and the second link 32 to perform a scissor action, enabling the key cap 2 to be lowered to compress the elastically deformable hollow actuation member 421 of the rubber membrane 42 and to further force the contact portion 422 of the elastically deformable hollow actuation member 421 into contact with the respective switching contact of the circuit board 41, and therefore the circuit board 41 is triggered to output a corresponding control signal. When the user released the hand from the key cap 2, the elastically deformable hollow actuation member 421 of the rubber membrane 42 immediately returns to its former shape subject to the effect of its elastic material property, thereby returning the key cap 2.

Further, during up stroke or down stroke of the key cap 2, two pivot pins 314 of the first link 31 are respectively moved in the sliding grooves 222 of the respective coupling members 22, and the pivot pins 323 of the second link 32 are rotated in the respective coupling holes 3121 of the first link 31, enabling the first link 31 and the second link 32 to perform a scissor action smoothly and stably.

Further, the first link 31 and the second link 32 can be made of metal or molded from plastics. Further, the arrangement of the pivot pins 323 and the coupling holes 3121 can be exchanged, i.e., the first link 31 can be made having a pivot pin protruded from each of the connection arms 312 and the second link 32 can be made having a coupling hole respectively located on each of the protruding reinforcing portions 326 for receiving the pivot pins at the connection arms 312 of the first link 31. Further, the linking mechanism can be used in a key switch assembly for mouse, keyboard, joystick or optical gun.

Further, the positioning plate 1 has two holes 14 disposed at two sides relative to the opening 11 and near the slot 12. When the key cap 2 is pressed and lowered to the lower limit position where the contact portion 422 of the elastically deformable hollow actuation member 421 touches the respective switching contact of the circuit board 41 and the first link 31 and second link 32 of the linking mechanism 3 are closely attached to the positioning plate 1, the coupling members 22 of the key cap 2 are respectively inserted through the opening 11 and slot 12 of the positioning plate 1 and the outwardly protruded and vertically thickened middle parts 3125 of the connection arms 312 of the first link 31. Therefore, the scissor-action design of the first and second links 31 and 32 of the linking mechanism 3 enables the height of the key switch assembly to be minimized, satisfying low-profile requirements.

Further, if the connection arms 312 are made straight, the formation of the coupling hole 3121 on each connection arm 312 will thin out the middle part of each connection arm 312 to lower the structural strength of the respective connection arm 312. By means of the design of the outwardly protruded and vertically thickened middle part 3125, the formation of the coupling hole 3121 on the outwardly protruded and vertically thickened middle part 3125 of each connection arm 312 does not affect the structural strength of the respective connection arm 312. Further, the formation of the opening 322 may affect the structural strength of the second link 32. The design of the two protruding reinforcing portions 326 greatly reinforces the structural strength of the flat base 321 of the second link 32. Further, the design of the sloping surface portions 3124 and the outwardly protruded and vertically thickened middle part 3125 of each of the connection arms 312 matches the configuration of the protruding reinforcing portions 326 of the second link 32 so that the second link 32 is receivable within the first link 31. Because the coupling holes 3121 and the pivot pins 323 are respectively located on the outwardly protruded and vertically thickened middle part 3125 of each of the connection arms 312 at an inner side and the protruding reinforcing portions 326 of the second link 32 at an outer side, the outwardly protruded and vertically thickened middle part 3125 of each of the connection arms 312 and the protruding reinforcing portions 326 of the second link 32 are strong enough to bear a great stress during a scissor action between the first link 31 and the second link 32, thereby prolonging the work life of the linking mechanism 3.

Further, the vertical grooves 313 on each of the two narrow elongated base portions 311 of the first link 31 are designed to match the coupling rods 324 of the second link 32. When coupling the water drop-like coupling holes 221 of two coupling members 22 of the key cap 2 to the respective coupling rods 324 of the second link 32, the respective coupling elements 2211 of the respective coupling members 22 can be inserted into the respective vertical grooves 313, facilitating the installation.

In actual practice, the linking mechanism of the present invention has the following features and advantages:

1. Because the first link 31 and second link 32 of the linking mechanism 3 are symmetrically configured in all directions, it is not necessary to consider the installation direction of the first link 31 and the second link 32 when fastening the linking mechanism 3 to the positioning plate 1 and the key cap 2, and therefore the invention facilitates fabrication and installation of the key switch assembly.

2. The design of the coupling hole 3121 on each of the connection arms 312 of the first link 31 at an inner side and the open sides 3122 on the top and bottom sides of the coupling hole 3121 enables the pivot pins 323 of the second link 3 to be coupled to the coupling holes 3121 of the first link 31 from the top side or the bottom side so that the user can selectively install the first link 31 or the second link 32 at first when coupling the linking mechanism 3 to the coupling lugs 13 of the positioning plate 1. Either the first link 31 or the second link 32 was installed at first, the pivot pins 323 of the second link 32 can be accurately coupled to the respective coupling holes 3121. This installation convenience greatly improves the yield rate of the product.

3. The design of the outwardly protruded and vertically thickened middle part 3125 of the first link 31 and the protruding reinforcing portions 326 of the second link 32 avoids curving or breaking of the first link 31 and the second link 32 when the first link 31 and the second link 32 are moved relative each other to perform a scissor action, prolonging the work life of the linking mechanism 3.

In conclusion, the invention provides a linking mechanism 3 comprised of a first link 31 and a second link 32 for coupling between a positioning plate 1 and a key cap 2 for making a scissor action to stabilize vertical movement of the key cap 2 relative to the positioning plate 1, wherein the first link 31 and the second link 32 are symmetrically configured, facilitating installation.

Although a particular embodiment of the invention has been described in detail for purposes of illustration, various modifications and enhancements may be made without departing from the spirit and scope of the invention. Accordingly, the invention is not to be limited except as by the appended claims.

What the invention claimed is:

1. A linking mechanism used in a key switch assembly and coupled between a key cap, and a positioning plate above a circuit module for performing a scissor action to guide vertical movement of said key cap relative to said circuit module for enabling said key cap to be pressed by a user to trigger said circuit module in producing a control signal, wherein said linking mechanism comprises:
a first link obliquely coupled between two first coupling members of said key cap and two first coupling lugs of said positioning plate, said first link comprising two symmetrical narrow elongated base portions arranged in parallel and two symmetrical connection arms connected between said two narrow elongated base portions in a parallel manner, and a pivot pin respectively axially extended from each of two distal ends of each of said two symmetrical narrow elongated base portion, each said symmetrical connection arm having a middle part, a coupling hole located on said middle part at an inner side, each said coupling hole having a top open side and a bottom open side; and
a second link obliquely coupled between two second coupling members of said key cap and two second coupling lugs of said positioning plate, said second link comprising a flat base receivable in the space surrounded by said two symmetrical narrow elongated base portions and said two symmetrical connection arms of said first link, an opening cut through top and bottom sides of said flat base for the passing of an elastically deformable hollow actuation member of said circuit module, two pivot pins respectively perpendicularly extended from said left and right sides of said flat base on the middle and respectively coupled to the coupling holes of said two symmetrical narrow elongated base portions of said first link, two pairs of coupling rods respectively located on front and rear sides of said flat base and respectively coupled to said two second coupling members of said key cap and said two second coupling lugs of said positioning plate.

2. The linking mechanism as claimed in claim 1, wherein said two symmetrical narrow elongated base portions and said two symmetrical narrow elongated base portions of said first link constitute a configuration shaped like a rectangular open frame for the passing of said elastically deformable hollow actuation member of said circuit module.

3. The linking mechanism as claimed in claim 1, wherein each said connection arm of said first link has two beveled guide surface portions bilaterally disposed in each of the top open side and bottom open side of the respective coupling hole for guiding the pivot pins of said second link into the coupling holes of said first link during installation of said linking mechanism in said key switch assembly.

4. The linking mechanism as claimed in claim 1, wherein each said connection arm of said first link has the middle part thereof protruded outwardly and vertically thickened to provide two sloping surface portions at an outer side; said flat base of said second link has two protruding reinforcing portions respectively located on the left and right sides thereof to support said pivot pins.

5. The linking mechanism as claimed in claim 1, wherein each said narrow elongated base portion of said first link has two vertical grooves disposed at an inner side at locations corresponding to the coupling rods of said second link.

6. The linking mechanism as claimed in claim 1, wherein said second link has two symmetrical pairs of holes respectively located on the front and rear sides thereof, and the coupling rods of said second link respectively suspend in the two symmetrical pairs of holes.
